(19) United States
(12) Patent Application Publication
(10) Pub. No.: US 2020/0129995 A1
(43) Pub. Date: Apr. 30, 2020

(54) Directable Dual Showerhead Diverter and Support Apparatus

(71) Applicant: Eli Zhadanov, Linden, NJ (US)

(72) Inventor: Eli Zhadanov, Linden, NJ (US)

(21) Appl. No.: 16/173,050

(22) Filed: Oct. 29, 2018

(51) Int. Cl. B05B 1/16; B05B 1/18; B05B 15/654

(52) U.S. Cl. CPC B05B 1/1636; B05B 15/654; B05B 1/185

(57) ABSTRACT

A directable dual showerhead diverter and support apparatus has a depending unit disposed rotatably projected from a diverter member. The depending unit includes at least one elongate member having a support member disposed at a lowermost end of the depending unit. The support member releasably secures a handheld showerhead unit therein erect and generally parallel the at least one elongate member. The depending unit is securable along an axis of rotation through a sagittal plane relative to a shower mains to which the diverter member is attached, between a rearmost position and a foremost position. Greater range of motion of the handheld showerhead unit is selectively enabled by securable reposition of the handheld showerhead unit interior to the support member. A user is thereby enabled greater selection of positions of the handheld showerhead unit to more particularly target water flow from the handheld showerhead unit hands free.

### CROSS-REFERENCE TO RELATED APPLICATIONS

Not Applicable

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

Various types of showerheads and diverters are known in the prior art. Many enable slidable position of a handheld showerhead unit along the length of a vertically disposed pole or rod by releasable action of some frictional device, such as a clamp or screw clamp for example. This enables selectable reposition of the handheld unit at a desired height up and down a vertical axis, but does not accommodate movement along a sagittal plane relative the shower mains itself. Most handheld showerhead units are not moveable at all but are fixed in a bracket or wall hanging.

What is needed is a directable dual showerhead diverter and support apparatus that includes a depending unit rotatably connected to the diverter member that is selectively positionable along an axis of roation wihtin a sagittal plane relative to the shower mains to which the diverter member is attached, whereby a user may securably reposition the handheld showerhead unit at a desired location between a rearmost position, closest the shower wall, and a foremost position, most proximal a user when standing in the shower.

In some embodiments, additional ranges of securable position are contemplated, wherein the handheld showerhead unit is further securable between a lowermost position and an uppermost postion effected interior to a support member disposed upon the depending unit, whereby the handheld showerhead unit is further articulable to extend the range of positions employable by action of the depending unit as well.

### FIELD OF THE INVENTION

The present invention relates to dual showerhead diverters and support apparatuses and, more particularly, to an improved means to secure a handheld showerhead unit at a desired position in a shower while controlling water flow between each of a first outlet, connected to the handheld showerhead unit, and a second outlet delivering water flow to an existing showerhead attached thereto or, in some embodiments, through an integrated showerhead conjoined therewith.

The instant directable dual showerhead diverter and support apparatus, therefore, includes means of securably positioning and repositioning a handheld showerhead unit along a sagittal plane relative to the shower mains to which a diverter member is also installed. A depending unit, disposed downwardly projected from the diverter member, includes at least one elongate member rotatably secured to the diverter member at an uppermost end of said depending unit. A support member is disposed at a lowermost end of the depending unit wherein the handheld showerhead unit is securable in an erect position generally parallel with the at least one elongate member comprising the depending unit.

The depending unit, rotatably attached to the diverter member at the uppermost end, is therefore enabled travel between a rearmost position (closest the shower wall whereon the shower mains is projected) and a foremost position (most proximal the central interior of the shower itself, and thus closest a user standing in the shower when facing the shower mains) whereby a user may selectively position the depending unit and secure it where desired between the rearmost and foremost positions. The handheld showerhead unit, therefore, is selectively positionable interior to the shower space for hands free, directed discharge of water flow, as desired.

Further articulation of the desired water flow is enabled in additional embodiments where a support member, engaging the handheld showerhead unit at the depending unit lowermost end, enables pivotal motion of the handheld showerhead unit by action of a pivoting bracket disposed interior to a U-shaped recess disposed within the support member to engage the handle of the handheld showerhead unit. In at least one embodiment contemplated herein, the support member is itself rotatably mounted laterally at the lowermost end of the at least one elongate member comprising the depending unit, whereby the handheld showerhead unit is rotatably positionable at the lowermost end even while the depending unit is securable between the rearmost and foremost positions.

A greater range of positions of the handheld showerhead unit is thereby contemplated whereby water flow may be targeted more precisely by a user, and in closer proximity to the user, than is presently seen in the art.

### SUMMARY OF THE INVENTION

The general purpose of the directable dual showerhead diverter and support apparatus, described subsequently in greater detail, is to enable securable position of a handheld showerhead unit along a sagittal plane relative a shower mains whereby discharge of water flow by the handheld showerhead unit is directable between a rearmost position and a foremost position and, consecutively, between a lowermost position and an uppermost position.

The present directable dual showerhead diverter and support apparatus, therefore, includes a depending unit rotatably attached to, and downwardly projected from, a diverter member. The depending unit is rotatably connected to the diverter member at an uppermost end of the depending unit. The depending unit further includes at least one elongate member having a support member terminally disposed thereupon, at a lowermost end of the depending unit.

The support member is disposed to releasably engage a handheld shower unit interior to a U-shaped recess, said handheld showerhead unit thereby maintainable in an erect position generally parallel with the at least one elongate member. The support member thereby enables securement of the handheld showerhead unit therein and enables securable position of the handheld shower unit between a rearmost and a foremost position of the depending unit when secured along an axis of rotation through a sagittal plane relative a shower mains to which the diverter member is attached, as will be explained herein below.

The support unit may further include a pivoting bracket disposed interiorly within the U-shaped recess. The pivoting bracket is disposed to releasably engage the handheld showerhead unit while enabling securable pivoting between a lowermost position and an uppermost position. In another example embodiment contemplated herein, the support member is rotatably attached laterally at the lowermost end of the depending unit, thereby enabling rotation of the handheld showerhead unit when secured therein through a range of motion (which may include 360°) disposed at the lowermost end of the depending unit. Coupled with the range of motion of the depending unit between the rearmost position and the foremost position, securable position of the handheld showerhead unit is enabled to direct water flow at a variety of places resulting from the dual rotations of the depending unit proper and the handheld showerhead unit itself maneuverable interior to the support member.

Thus the handheld showerhead unit is securable interior to the support member and thence positioned at a desired position along an axis of rotation along a sagittal plane relative to the shower mains, whereat the handheld showerhead unit is yet further positionable between the lowermost position and the uppermost position by action of the pivoting bracket interior to the U-shaped recess or, in some embodiments, by rotation of the support member itself when said support member is laterally disposed for rotation at the lowermost end of the depending unit.

The diverter member, then, includes an inlet, a first outlet, and a second outlet. The inlet is disposed for attachment to an existing shower mains. The first outlet is disposed approximately 90° from the inlet upon a basal side of the diverter member. The first outlet is disposed for attachment to a line connecting the handheld showerhead unit. In an example embodiment herein contemplated, the second outlet is disposed for attachment to an adjustable arm of an existing showerhead whereby typical showerheads as seen in the art are connectable thereto. The adjustable arm of the existing showerhead enables a range of motion of the existing showerhead thereabouts when attached to the second outlet, as seen in the art. In a second example embodiment contemplated herein, the second outlet is disposed interior to an integrated showerhead that is integrated with the diverter member. In this example embodiment the integrated showerhead is conjoined to the diverter member and projected anteriorly thereupon. To enable adjustable position of the integrated showerhead, a ball joint is incorporated in this embodiment at the diverter member inlet, whereby the entire diverter member is positionable about a range of motion at the inlet, as controlled by the ball joint therein disposed.

The diverter member includes at least one valve disposed interiorly therein to control water flow between the inlet and each of the first and second outlets. At least one switch upon the diverter member is included to enable manual selection to control water flow through the diverter member between the inlet and each of the first and second outlets and, alternately, to secure the depending unit at a desired position through the axis of rotation along the sagittal plane relative to the shower mains.

In the example embodiment contemplated herein enabling attachment of an existing showerhead, the diverter member has a first end and a second end. In this example embodiment, the at least one switch includes a first switch (situated at the first end) and a second switch (situated at the second end). The first switch is rotatably disposed upon the diverter member at the first end to enable selection of water flow between the first and second outlet, thereby directing water flow through the existing showerhead, the handheld showerhead unit, or both. The second switch is rotatably disposed at the second end to enable release and securement of the depending unit along the axis of rotation through the sagittal plane relative the shower mains to enable selectable positioning of the depending unit at a desired angle between the rearmost and the foremost positions wherefrom water discharge from the handheld showerhead unit is most desirable.

Thus has been broadly outlined the more important features of the present directable dual showerhead diverter and support apparatus so that the detailed description thereof that follows may be better understood and in order that the present contribution to the art may be better appreciated.

Objects of the present directable dual showerhead diverter and support apparatus, along with various novel features that characterize the invention are particularly pointed out in the claims forming a part of this disclosure. For better understanding of the directable dual showerhead diverter and support apparatus, its operating advantages and specific objects attained by its uses, refer to the accompanying drawings and description.

### BRIEF DESCRIPTION OF THE DRAWINGS

### Figures

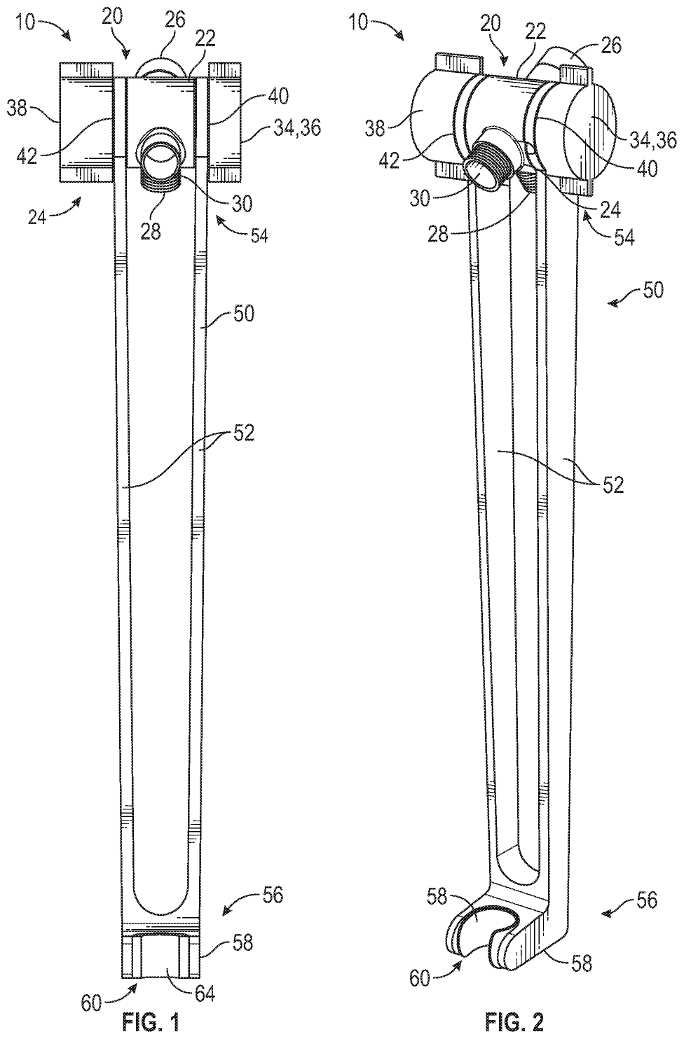

FIG. 1 is a front elevation view of an example embodiment having a depending unit with a pair of elongate members.

FIG. 2 is an isometric view of the example embodiment illustrated in FIG. 1.

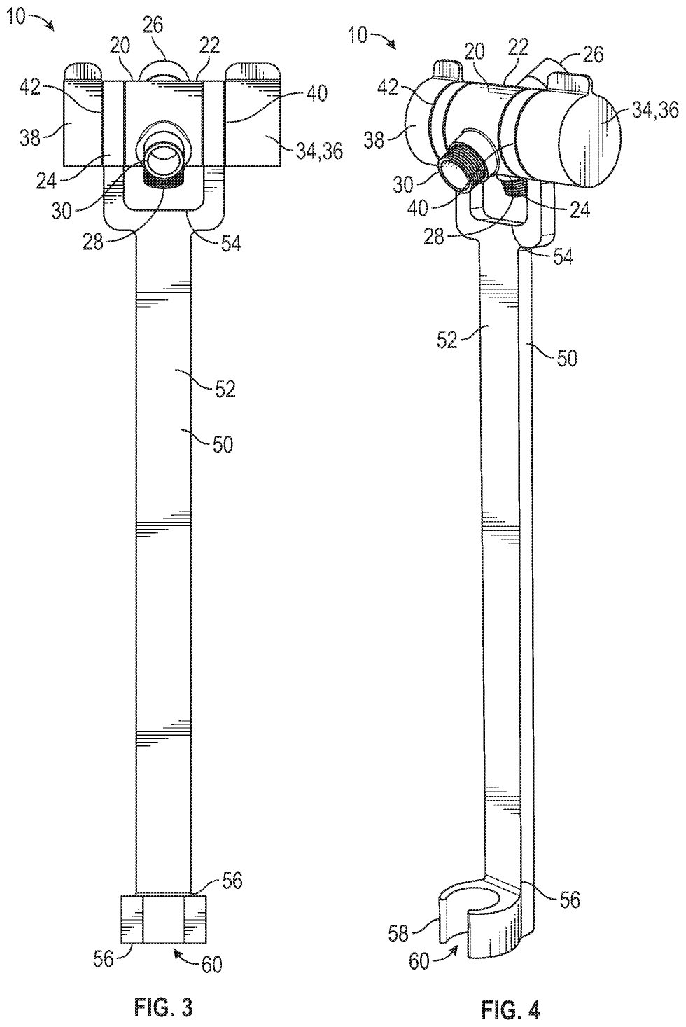

FIG. 3 is a front elevation view of an example embodiment having a depending unit comprising a single elongate member.

FIG. 4 is an isometric view of the example embodiment illustrated in FIG. 3.

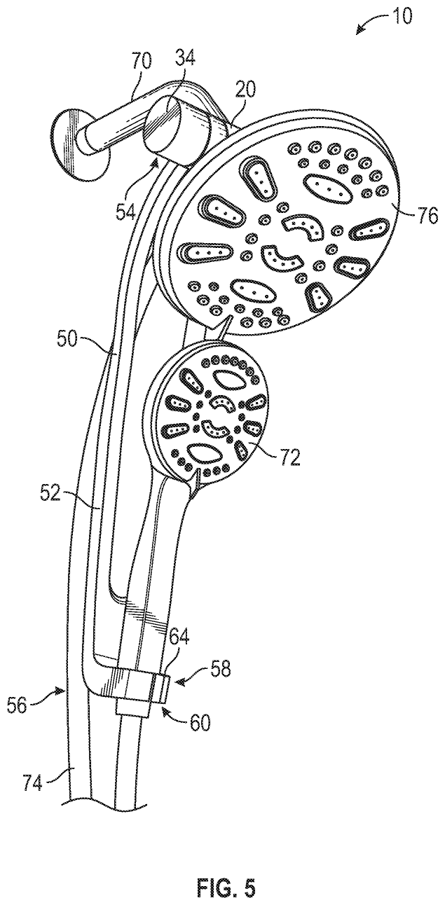

FIG. 5 is an isometric view of an example embodiment of the directable dual showerhead diverter and support apparatus installed to a shower mains and having a handheld showerhead unit attached by a water line to a first outlet and an existing showerhead attached at a second outlet, said handheld showerhead unit secured interior to a U-shaped recess of a support member at the lowermost end of the depending unit.

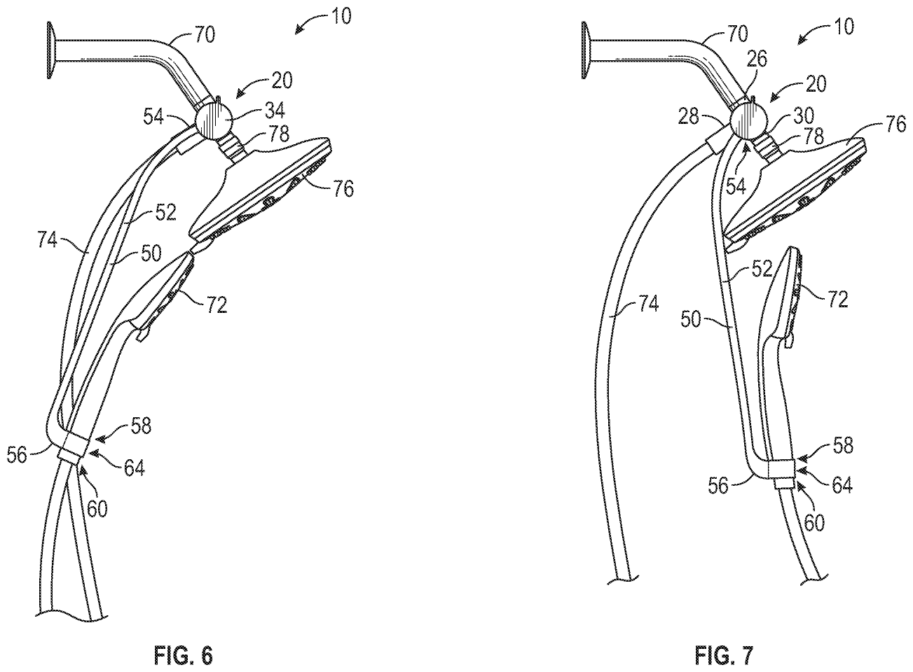

FIG. 6 is a side elevation view of the example embodiment illustrated in FIG. 5 and having the depending unit secured in a rearmost position.

FIG. 7 is a side elevation view of the example embodiment illustrated in FIG. 5 and having the depending unit secured in a foremost position.

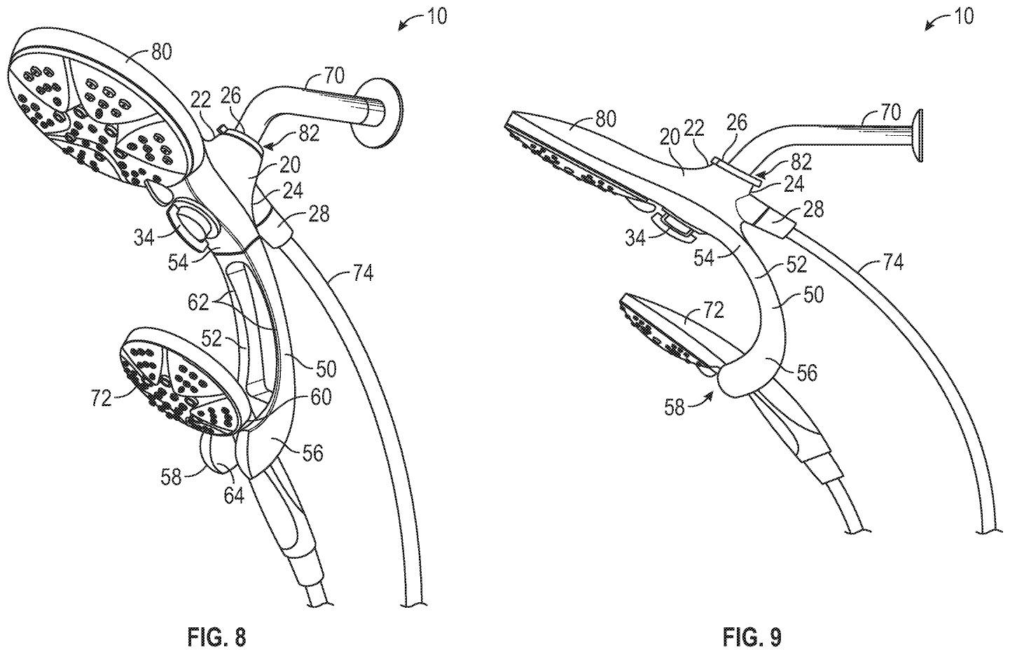

FIG. 8 is an isometric view of an example embodiment of the directable dual showerhead diverter and support apparatus installed to a shower mains and having a handheld showerhead unit attached by a water line to a first outlet secured interior to a U-shaped recess of a support member at the lowermost end of the depending unit and an integrated showerhead conjoined to the diverter member wherein the second outlet is disposed interiorly to the integrated showerhead.

FIG. 9 is a side elevation view of the example embodiment illustrated in FIG. 8.

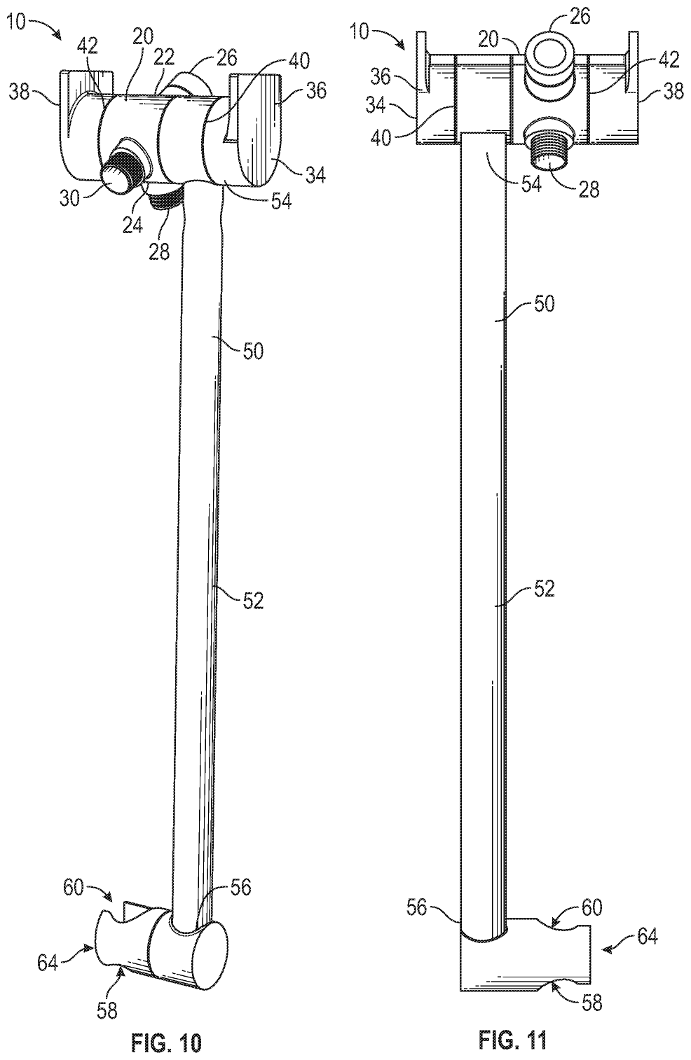

FIG. 10 is an isometric view of an example embodiment having a support member disposed rotatably upon a single elongate member at the lowermost end of the depending unit.

FIG. 11 is a rear elevation view of the example embodiment illustrated in FIG. 10.

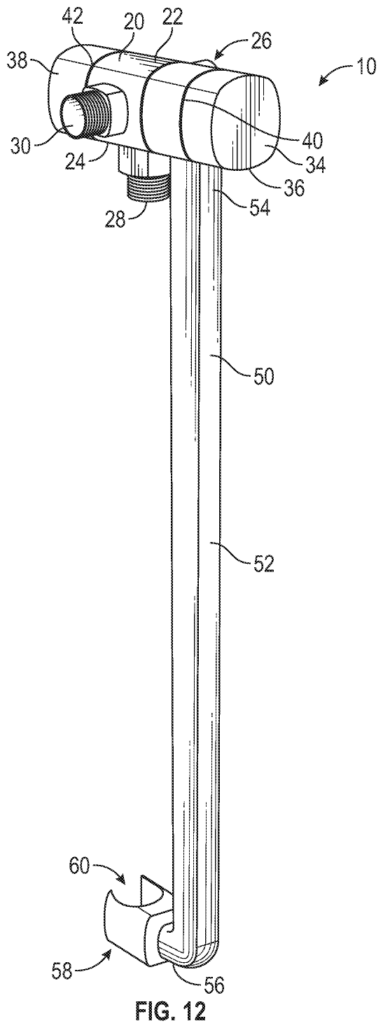

FIG. 12 is an isometric view of another example embodiment having a support member disposed rotatably upon a single elongate member at the lowermost end of the depending unit.

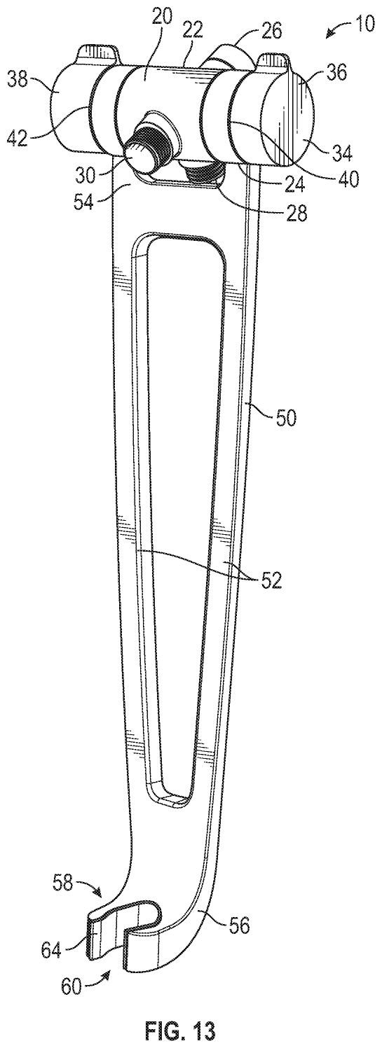

FIG. 13 is an isometric view of another example embodiment of the directable dual showerhead diverter and support apparatus.

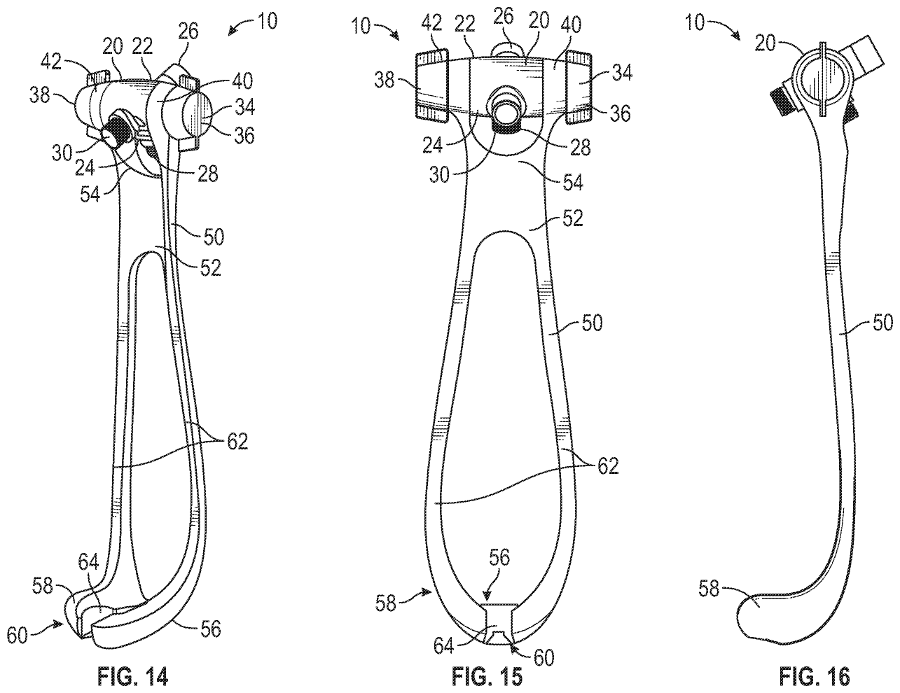

FIG. 14 is an isometric view of another example embodiment of the directable dual showerhead diverter and support apparatus.

FIG. 15 is a front elevation view of the example embodiment illustrated in FIG. 14.

FIG. 16 is a side elevation view of the example embodiment illustrated in FIG. 14.

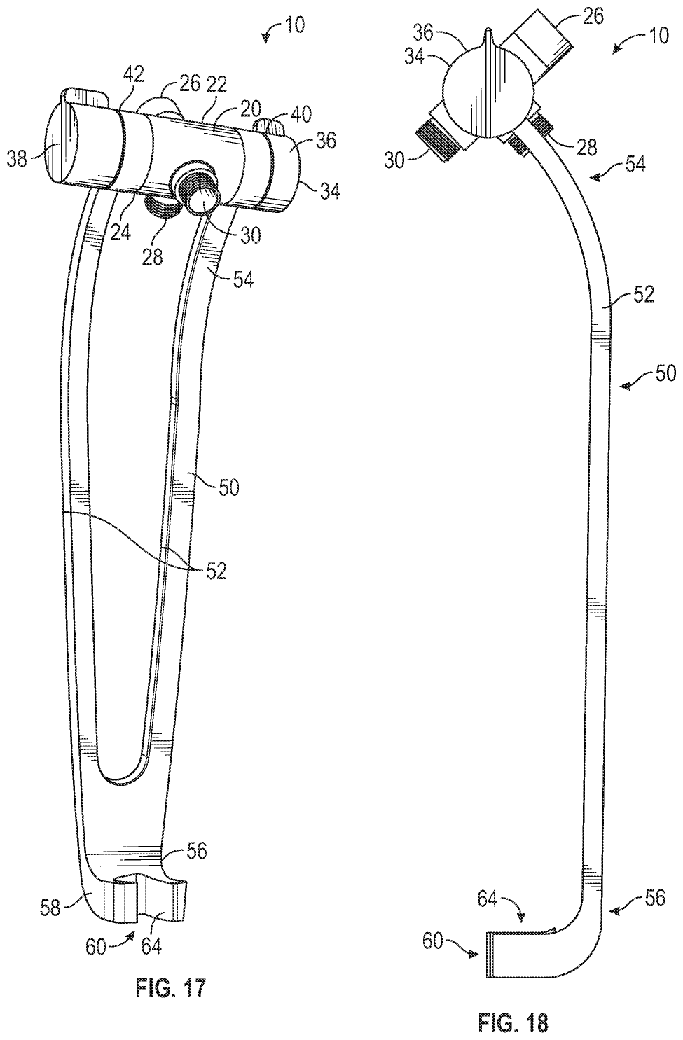

FIG. 17 is an isometric view of another example embodiment of the directable dual showerhead diverter and support apparatus.

FIG. 18 is a side elevation view of the example embodiment illustrated in FIG. 17.

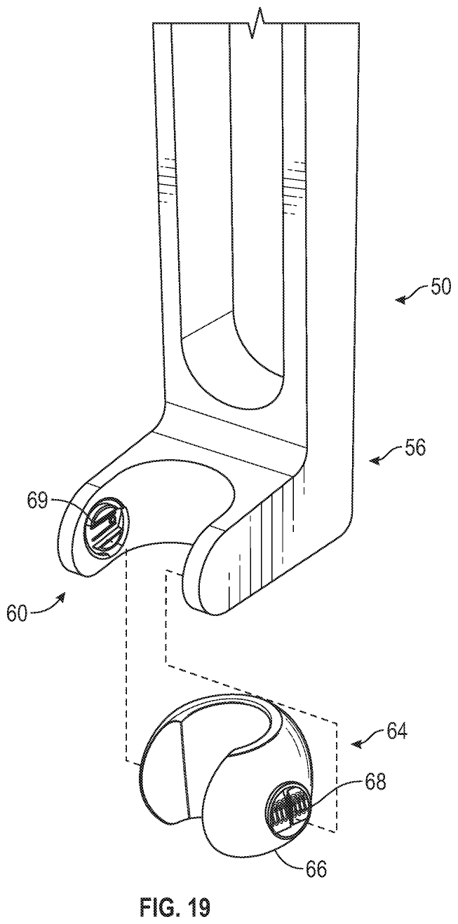

FIG. 19 is a detail view of an example embodiment of a pivoting bracket disposed in a U-shaped recess upon a support member.

### DETAILED DESCRIPTION OF THE DRAWINGS

With reference now to the drawings, and FIGS. 1 through 19 thereof, example of the instant directable dual showerhead diverter and support apparatus employing the principles and concepts of the present directable dual showerhead diverter and support apparatus and generally designated by the reference number 10 will be described.

In all embodiments, the present directable showerhead diverter and support apparatus 10 includes a diverter member 20 that is connectable to a shower mains 70 and has a depending unit 50 rotatably disposed thereupon. The depending unit 50 is devised to support and securably position a handheld showerhead unit 72 along a sagittal plane relative to the shower mains 70, between a rearmost position and a foremost position, whereby water flow discharged from the handheld showerhead unit 72 is directable even when the handheld showerhead unit 72 is disposed supported by the depending unit 50 and engaged therewith. The handheld showerhead unit 72 water line 74 is maintained rearwardly behind the depending unit 50 for tidy storage so that the line 74 does not interfere with the range of motion of the depending unit 50 between the rearmost and foremost positions. See for example FIGS. 6 and 7.

In an example embodiment illustrated in FIGS. 1 through 7 and FIGS. 10 through 17, the diverter member 20 includes a dorsal side 22 and a basal side 24. An inlet 26 is disposed upon the dorsal side 22, said inlet 26 connectable to the existing shower mains 70 (see for example FIG. 6). A first outlet 28 is disposed upon the basal side 24 at approximately 90° relative to the inlet 26, said first outlet 28 connectable to a line 74 of the handheld showerhead unit 72. A second outlet 30 is disposed anteriorly upon the diverter member 20, said second outlet 30 disposed at approximately 90° relative to the first outlet 28. At least one valve member (not shown) is disposed interior to the diverter member 20, therein operable to control water flow through the diverter member 20 between the inlet and each of the first and second outlets 28, 30. At least one switch 34 is disposed upon the diverter member 20, said at least one switch 34 devised to enable manual selection of controlled water flow through the diverter member 20 and, alternately, to secure the depending unit 50 between the rearmost and foremost positions. In the embodiments illustrated in FIGS. 1 through 7 and FIGS. 10 through 17, the at least one switch 34 includes a first switch 36 and a second switch 38.

The depending unit 50 includes at least one elongate member 52 having an uppermost end 54 and a lowermost end 56. The at least one elongate member 52 depends from the diverter member 20 by rotatable attachment at the uppermost end 54 and remains unconnected at the lowermost end 56. The at least one elongate member 52 is thereby rotatable through a sagittal plane relative to the shower mains 70 between the rearmost position and the foremost position. A support member 58 is disposed terminally upon the depending unit 50 at the lowermost end 56, said support member 58 including a U-shaped recess 60 devised to engage to a handle of an existing handheld showerhead unit 72 therein and support said existing handheld showerhead unit 72 upright generally parallel with the at least one elongate member 52. The at least one elongate member 52 is situated depending from the diverter member 20 to maintain a range of positions between the first outlet 28 and the second outlet 30 whereby the handheld showerhead unit 72 line 74 is maintained rearwardly behind the at least one elongate member 52 when the handheld showerhead unit 72 is secured in the support member 58 whereby the at least one elongate member 52 generally conceals the line 74 therebehind.

In an example embodiment depicted in FIGS. 5, 6, 7, 8, 9, 1314, 15, 16, 17, and 18, the at least one elongate member 52 includes a pair of arcuate members 62 arcuately disposed depended from the diverter member 20 whereby the support member 58 is disposed conjoining the pair of arcuate members 62 at the lowermost end 56 of the depending unit 50.

The depending unit 50 is securably positionable between the rearmost position and the foremost position through an axis of rotation whereby discharge from the handheld showerhead unit 72 is directable while the handheld showerhead unit 72 is still engaged in the support member 58. The handheld showerhead unit 72 may be separated from engagement with the support member 58 by manual action to release the handheld showerhead unit 72 for handheld operation of the handheld showerhead unit 72, as desired. Further, for additional control to direct water flow discharged from the handheld showerhead unit 72, in some embodiments the support unit 58 also includes a pivoting bracket 64 disposed interior to the U-shaped recess 60. See for example FIG. 19. The pivoting bracket 64 includes a nested hasp member 66 disposed rotatably seated interior to the U-shaped recess 60. A pair of diametrically opposed projections 68 is disposed exteriorly upon the nested hasp member 66 rotatably engage interior to a corresponding seats 69 interior disposed within the pivoting bracket 64 whereby the nested hasp member 66 is movable between a lowermost position and an uppermost position whereby the handheld showerhead unit 72 is securable and positionable between the lowermost and the uppermost positions and frictionally engaged interior to the U-shaped recess 60.

In the example embodiment depicted in FIGS. 10, 11, and 12, the support member 58 itself is rotational and is therefore rotatably disposed laterally upon the lowermost end 56 of the elongate member 52 of the depending unit 50, thus enabling rotation of the handheld showerhead unit 72 when disposed therein around an axis of rotation at the lowermost end 56 of the depending unit 50 coplanar with the sagittal plane through which the depending unit 50 is likewise rotational between the rearmost and the foremost positions.

Thus, in all embodiments contemplated herein, a range of positions is enabled whereby discharge from the handheld showerhead unit 72 is directable from the depending unit's 50 rearmost position to the foremost position and the pivoting bracket's 64 lowermost position and uppermost position.

In the example embodiments illustrated in FIGS. 1 through 7 and FIGS. 10 through 17, the second outlet 30 is connectable to an adjustable arm 78 of an existing showerhead 76 (as shown in FIGS. 6 and 7 for example). The diverter member 20 therefore attaches to the shower mains 70 at the inlet 26 and to the showerhead 76 at the second outlet 30 to situate the depending unit 50 for use with an existing handheld showerhead unit 72 attached by a line 74 to the first outlet 28. In these example embodiments, the existing showerhead 76 is moveable around a range of positions articulated by the existing adjustable arm 78 that effects attachment of the existing showerhead 76 to the second outlet 30.

In these example embodiments also, the at least one switch 34 includes a first switch 36 and a second switch 38 disposed at opposite ends (a first end 40 and a second end 42 respectively) of the diverter member 20. Each of the first switch 36 and the second switch 38 are thereat rotatable between a first position and a second position. The first switch 36 is rotatable to manually control water flow between each of the first and second outlets 28, 30, and the second switch 38 is rotatable to release and secure the depending unit 50 between the rearmost and the foremost positions.

In the example embodiment illustrated in FIGS. 8 and 9, however, the second outlet 30 is disposed interior to an integrated showerhead 80 integrated and conjoined with the diverter member 20. In this example embodiment the integrated showerhead 80 therefore is conjoined with the diverter member 20 and is not separable therefrom. To enable position of the integrated showerhead 80 as desired by a user showering, the inlet 26 therefore includes a ball joint 82, as seen in the art, to enable a range of motion of the diverter member 20 at the point of contact with the shower mains 70.

Thus, in any embodiment exemplified herein, a user is enabled to direct water flow through either the existing showerhead 76 or the integrated showerhead 80 and also position the handheld showerhead unit 72 upon the depending unit 50 in a desired position through an increased range of positions articulated by the depending unit 50 in conjunction with the pivoting bracket 64 engaging with the handheld showerhead unit 72 interior to the U-shaped recess 60 of the support member 58. Greater diversity in water flow is therefore enabled.

What is claimed is:

1. A directable showerhead diverter and support apparatus comprising:
a diverter member connectable to an existing shower mains, said diverter member including a showerhead and a handheld showerhead unit;
a depending unit rotatably disposed endwise upon the diverter member, said depending unit having:
at least one elongate member having an uppermost end and a lowermost end, said at least one elongate member depended from the diverter member by rotatable attachment at the uppermost end and unconnected at the lowermost end, said at least one elongate member thereby rotatable through a sagittal plane relative to the shower mains between a rearmost position and a foremost position; and
a support member disposed terminally upon the depending unit at the lowermost end, said support member including a U-shaped recess devised to engage to a handle of an existing handheld showerhead unit therein and support said existing handheld showerhead unit upright generally parallel with the at least one elongate member;
wherein the depending unit is positionable between the rearmost position and the foremost position whereby discharge from the handheld showerhead unit is directable when the handheld showerhead unit is engaged in the support member.

2. The directable dual showerhead diverter and support apparatus of claim 1 wherein the diverter member includes:
a dorsal side;
a basal side;
to an inlet disposed upon the dorsal side connectable to the existing shower mains;
a first outlet disposed upon the basal side at approximately 90° relative to the inlet, said first outlet connectable to a line of the handheld showerhead unit;
a second outlet disposed anteriorly upon the diverter member, said second outlet disposed at approximately 90° relative to the first outlet;
at least one valve member disposed interior to the diverter member, said at least one valve operable to control water flow through the diverter member between the inlet and each of the first and second outlets; and
at least one switch disposed upon the diverter member;
wherein the at least one valve member is manually controllable to direct water flow through the diverter member from the inlet to each of the first and second outlets and wherein the depending unit is securable between the rearmost and the foremost position.

3. The directable dual showerhead diverter and support apparatus of claim 2 wherein the support unit further comprises a pivoting bracket disposed interior to the U-shaped recess, said pivoting bracket movable between a lowermost position and an uppermost position whereby the handheld showerhead unit is securable and positionable between the lowermost and the uppermost positions interior to the U-shaped recess.

4. The directable dual showerhead diverter and support apparatus of claim 2 wherein the support member is rotatably disposed laterally upon the at least one elongate member at the lowermost end of the depending unit.

5. The directable dual showerhead diverter and support apparatus of claim 3 wherein the second outlet is attachable to an adjustable arm of an existing showerhead.

6. The directable dual showerhead diverter and support apparatus of claim 3 wherein the second outlet is disposed interior to an integrated showerhead integrated with the diverter member.

7. A directable dual showerhead diverter and support apparatus comprising:
a diverter member having a dorsal side and a basal side;
an inlet disposed upon the dorsal side, said inlet connectable to an existing shower mains;
a first outlet disposed upon the basal side, said first outlet connectable to a line of an existing handheld showerhead unit;
a second outlet disposed anteriorly upon the diverter member;
at least one valve member disposed interior to the diverter member, said at least one valve member directable to control water flow interior to the diverter member;
a depending unit rotatably disposed upon the diverter member, said depending unit depending at least one elongate member arcuately projected downward beneath the diverter member and thereat moveable within a sagittal plane relative the existing shower mains;
a support member disposed terminally upon the depending unit at a lowermost end thereof, said support member including a U-shaped recess devised to engage to a handle of the existing handheld showerhead unit therein and support said existing handheld showerhead unit upright generally in parallel with the at least one elongate member; and
at least one switch disposed upon the diverter member, said at least one switch disposed in operational communication with the at least one valve member to regulate water flow between the first outlet and the second outlet;
wherein the depending unit is securable between a rearmost position and a foremost position whereby discharge from the handheld showerhead unit is directable when the handheld showerhead unit is engaged in the support member.

8. The directable dual showerhead diverter and support apparatus of claim 7 further comprising:
a ball joint disposed at the inlet connectable to the existing shower mains; and
an integrated showerhead integrated with the second outlet and the diverter member;
wherein the showerhead is positionable around a range of motion controlled by the ball joint.

9. The directable showerhead diverter and support apparatus of claim 7 wherein the second outlet is disposed at approximately 90° relative to the first outlet, and said second outlet is attachable to an adjustable arm of an existing shower head.

10. The directable dual showerhead diverter and support apparatus of claim 8 wherein the at least one switch is disposed anteriorly upon the diverter member proximal the integrated showerhead.

11. The directable showerhead diverter and support apparatus of claim 9 wherein the diverter member further includes a first end and a second end.

12. The directable showerhead diverter and support apparatus of claim 10 wherein the at least one elongate member includes a pair of arcuate members disposed in parallel wherein the support member is disposed terminally between the pair of arcuate members at the lowermost end.

13. The directable showerhead diverter and support apparatus of claim 11 wherein the diverter member further includes:
a first switch disposed upon the first end of the diverter member, said first switch disposed in operational communication with the at least one valve member, said first switch manually operable between at least a first position and a second position to control water flow between the first outlet and the second outlet; and
a second switch disposed upon the second end of the diverter member, said second switch disposed to releasably secure the depending unit through an axis of rotation between the rearmost position and the foremost position along the sagittal plane relative to the shower mains.

14. The directable showerhead diverter and support apparatus of claim 12 wherein the U-shaped recess includes a pivoting bracket disposed therein, said pivoting bracket movable between a lowermost position and an uppermost position, said pivoting bracket devised to releasably engage to the handle of the existing handheld showerhead unit, wherein discharge from the existing handheld showerhead unit is further directable when the handheld showerhead is engaged in the support member.

15. The directable dual showerhead diverter and support apparatus of claim 13 wherein the support member is rotatably disposed laterally upon the at least one elongate member at the lowermost end of the depending unit.

16. The directable showerhead diverter and support apparatus of claim 13 wherein the U-shaped recess includes a pivoting bracket disposed therein, said pivoting bracket movable between a lowermost position and an uppermost position, said pivoting bracket devised to releasably engage to the handle of the existing handheld showerhead unit, wherein discharge from the existing handheld showerhead unit is directable when the handheld showerhead is engaged in the support member.

17. The directable showerhead diverter and support apparatus of claim 16 wherein the at least one elongate member includes a pair of arcuate members disposed in parallel wherein the support member is disposed terminally between the pair of arcuate members.

18. A directable showerhead diverter and support apparatus comprising:
a diverter member having a dorsal side and a basal side;
an inlet disposed upon the dorsal side, said inlet connectable to an existing shower mains;
a ball joint disposed at the inlet, said ball joint enabling a range of motion of the diverter member when attached to the existing shower mains;
a first outlet disposed upon the basal side, said first outlet connectable to a line of an existing handheld showerhead unit;
a second outlet disposed anteriorly upon the diverter member;
an integrated showerhead integrated with the second outlet and the diverter member, said integrated showerhead disposed extended upward from the diverter member;
at least one valve member disposed interior to the diverter member, said at least one valve member directable to control water flow interior to the diverter member;
a depending unit rotatably disposed upon the diverter member, said depending unit depending at least one elongate member arcuately projected downward beneath the diverter member and thereat moveable within a sagittal plane relative the existing shower mains;
a support member disposed terminally upon the depending unit at a lowermost end thereof, said support member including a U-shaped recess devised to engage to a handle of an existing handheld showerhead unit therein and support said existing handheld showerhead unit upright generally parallel with the at least one elongate member;
a pivoting bracket disposed interior to the U-shaped recess, said pivoting bracket movable between a lowermost position and an uppermost position; and
at least one switch disposed anteriorly upon the diverter member proximal the integrated showerhead, said at least one switch disposed in operational communication with the at least one valve member to regulate water flow between the first outlet and the second;
wherein the depending unit is securable between a rearmost position and a foremost position whereby discharge from the handheld showerhead unit is directable when the handheld showerhead unit is engaged in the support member.

19. A directable dual showerhead diverter and support apparatus comprising:
a diverter member having a dorsal side, a basal side, a first end, and a second end;
an inlet disposed upon the dorsal side, said inlet connectable to an existing shower mains;
a first outlet disposed upon the basal side, said first outlet attachable to an existing handheld showerhead line;
a second outlet disposed anteriorly upon the diverter member approximately 90° from the first outlet, said second outlet attachable to an existing showerhead unit;
at least one valve member disposed interior to the diverter member, said at least one valve member directable to control flow interior to the diverter member between the inlet and each of the first and second outlets;
a depending unit rotatably disposed upon the diverter member depending at least one elongate member downward beneath the diverter member, said depending unit rotatably moveable within a sagittal plane relative the existing shower mains;
a support member disposed terminally upon the depending unit at a lowermost end thereof, said support member including a U-shaped recess devised to engage to a handle of an existing handheld showerhead therein and support said existing handheld unit upright in parallel with the at least one elongate member;
a pivoting bracket disposed interior to the U-shaped recess, said pivoting bracket movable a lowermost position and an uppermost position;
a first switch disposed upon the first end of the diverter member, said first switch disposed in operational communication with the at least one valve member, said first switch manually operable between at least a first position and a second position to control water flow between the first outlet and the second outlet; and
a second switch disposed upon the second end of the diverter member, said second switch disposed to releasably secure the depending unit along an axis of rotation along the sagittal plane relative to the shower mains;
wherein the depending unit is securable between a rearmost position and a foremost position whereby discharge from the handheld showerhead unit is directable when the handheld showerhead is engaged in the support member.
